(19) United States
(12) Patent Application Publication
(10) Pub. No.: US 2024/0060257 A1
(43) Pub. Date: Feb. 22, 2024

(54) CONCENTRIC TIRE STRUCTURE AND METHOD FOR MAKING THE SAME

(71) Applicant: YELLOWSTONE TIRE, LLC, IDAHO FALLS, ID (US)

(72) Inventor: Bill Russell, Pocatello, ID (US)

(21) Appl. No.: 18/453,964

(22) Filed: Aug. 22, 2023

Related U.S. Application Data
(60) Provisional application No. 63/399,965, filed on Aug. 22, 2022.

(51) Int. Cl. E01F 15/14; E01B 26/00; E04C 1/40; E04H 17/14; E04C 3/36; E01C 3/00; E02D 27/01; E02D 29/02; E01F 15/02; E02B 11/00

(52) U.S. Cl. CPC E01F 15/14; E01B 26/00; E04C 1/40; E04H 17/1404; E04C 3/36; E01C 3/006; E02D 27/01; E02D 29/0266; E01F 15/02; E01C 3/003; E02B 11/00; E02D 2300/0003; E02D 2200/1621; F41H 5/24

(57) ABSTRACT

Responsive to the difficulties encountered in recycling, disposing of, and repurposing spent tires, as well as the need for durable construction materials, concentric tire structures and methods for making the same are provided herein.

### RELATED APPLICATIONS

This United States patent application claims the benefit of U.S. Provisional Patent Application Ser. No. 63/399,965, filed Aug. 22, 2022, which is incorporated herein by reference in its entirety.

### FIELD OF THE INVENTION

The present invention relates to the repurposing of tires, and more particularly to a versatile structure created from spent or worn-out tires and methods for making said structure.

### BACKGROUND OF THE INVENTION

As tires wear out all over the world, spent tires often find their way into scrapyards and landfills. These tires are a challenging source of waste due to their non-biodegradable and highly durable nature, as well as the extremely large quantity of tires produced annually and the wide variety of ecologically problematic components in tires that can lead to rubber pollution, heavy metal toxicity, and similar issues. Moreover, due to the large proportion of negative space in each tire (approximately 75% per tire) and the difficulty of compressing tires, tires take up valuable space in landfills and scrap stockpiles. Moreover, the void space in tires can trap methane gas, causing them to become buoyant and bubble to the landfill surface, which can damage landfill liners and cause pollutants to escape into local water supplies. Furthermore, tire stockpiles can harbor vermin and insects that carry disease. They are also great fire risks, as tire fires can start easily and burn for weeks to months at a time, causing substantial air and ground pollution.

In an effort to deal with these difficulties, several methods of recycling tires have emerged, such as burning them in the cement-making process, using them as a carbon source for steel manufacturing, shredding them, or grinding them into crumb rubber. Unfortunately, such applications are often high-emission, high-pollution activities that can be even more damaging to the environment than burying them in landfills.

As a consequence of the above, efforts are sometimes made to repurpose tires as opposed to fully recycle them. For example, tires may be bound together and used as barriers for collision reduction, erosion control, and sound barriers. Spent tires may also be used in civil engineering applications, such as road insulation, landfill projects, and land grading techniques, or filled with concrete and used as building materials. Another example of repurposing tires is using them as a swing or other playground equipment.

Unfortunately, however, many of these repurposing techniques have their own significant drawbacks. One large drawback is that the number of tires that may be repurposed in accordance with the above techniques is significantly limited by the large amount of space that a spent tire occupies. Thus, while the tires that can be used in a given project do indeed have a beneficial use, only a small number of such tires may be repurposed for the project, while many more tires still end up in landfills or environmentally harmful recycling applications.

Another severe drawback of current tire repurposing techniques is the large variance in tire size, which makes collecting uniform spent tires for use in projects requiring uniformity significantly more difficult, while simultaneously precluding the repurposing of tires of variant size for such projects. Yet another shortcoming of mainstream tire repurposing techniques is that large amounts of other materials are generally necessary to make the tires useful; for example, a large amount of concrete may be needed to fill the negative space of spent tires that will be used in a concrete barrier; or a large amount of soil may be needed to fill the gaps when tires are being used for erosion prevention.

Yet another drawback is that the durability of repurposed tires can be questionable, particularly when worn out or spent tires are used. Thus, worn tires incorporated into a project can quickly become unsuitable for the desired use, leading to a need for a sometimes costly and time-consuming replacement.

For these reasons, there are significant limitations to the current technology in the tire recycling and repurposing industry. These limitations remain unaddressed and limit the ability to incorporate a significant number of spent tires into useful applications without causing environmental harm. The present invention addresses and overcomes these limitations.

### BRIEF SUMMARY OF THE INVENTION

The instant invention is a concentric tire structure that may be formed from worn-out, spent, defective, and/or repurposed tires (including new tires), and a method for making the same. The tire structure is not only useful for repurposing old tires that may otherwise be a source of pollutants, an environmental hazard, a health hazard, a troublesome waste source, or a general nuisance, but the tire structure may also be incorporated into a wide variety of useful and beneficial structures and projects, thereby allowing substantial value to be derived from an otherwise problematic source of waste.

According to some implementations of the invention, the invention is a tire structure having multiple tires, such as at least a first tire and a second tire, but potentially many more tires. In some implementations, the tire structure contains as many as twenty (whole or partial) tires, but in many implementations, the tire structure contains up to twelve tires.

According to some implementations of the invention, the first tire in the tire structure is a modified tire that generally resembles an ordinary tire from which one of the sidewalls has been removed (on an unmodified tire, the sidewalls are the generally circular portions of the tire that face inward and outward when the tire is used on the wheel of a vehicle). Thus, according to some implementations the tire has an annular (or generally ring-shaped) tread area, which is the outer face of the tire (or the part of the tire that comes into contact with the surface of the road when the tire is in use on a vehicle wheel). Thus, according to some implementations, the first tire in the tire structure has one sidewall still attached, and the other sidewall is removed. The tire structure may be used in an upright position or laid on its side, but it is often assembled while the tires are laid on their side. Accordingly, and for purposes of clarity, the sidewall that is still attached will generally be referred to herein as the bottom sidewall, and the sidewall that has been removed will generally be referred to as the top sidewall (or the detached sidewall).

According to some implementations of the invention, the removal of the top sidewall creates an opening that leads to a tire cavity. Accordingly, the opening is defined by the top edge of the annular tread area. This is distinguished from an ordinary tire, which generally does not have an opening defined by the top edge of the annular tread area. Rather, an ordinary tire often has a hole that is defined by the inner edge of the circular sidewall. This hole leads to the tire cavity, but it is much smaller than the opening on a modified tire, so the opening provides greater access to the tire cavity.

According to some implementations of the invention, the bottom sidewall is not removed. Thus, in some implementations, the invention has a hole defined by the inner edge of the bottom sidewall (which is radially attached to the bottom edge of the annular tread area). This hole is opposite the opening (which is obtained by removal of the top sidewall). The opening allows for quick and efficient assembly of the tire structure, while the hole may have other uses, as discussed below.

According to some implementations of the invention, the second tire is concentrically disposed within the tire cavity of the first tire. For example, the second tire may be placed through the opening defined by the top edge of the annular tread area, and positioned so that the annular tread area of the second tire is facing, contacting, or substantially coming into contract with an inner face of the first tire. Thus, the first and second tires form a concentric tire structure.

According to some implementations of the invention, the first tire has a diameter that is larger than the diameter of the second tire. Thus, the second tire may more easily fit inside the tire cavity of the first tire. Notwithstanding the above, due to the elastic quality of many tires, the tires may also be tires of the same diameter, with the first tire being stretched or the second tire being compressed (or both) to allow for the second tire to be concentrically disposed within the first tire's cavity.

According to some implementations of the invention, a detached sidewall (such as the detached sidewall of the first tire) may be disposed between the first tire and the second tire. For example, if there are any gaps or spaces between the annular tread area of the second tire and the inner face of the first tire, the detached sidewall may be positioned within such a gap or space, thus decreasing the amount of negative space in the tire structure and increasing its density, durability, and/or structural integrity.

According to some implementations of the invention, the second tire, like the first, has its top sidewall removed. Thus, the second tire has a bottom sidewall that is radially attached to the bottom edge of an annular tread area, and an opening defined by a top edge of the annular tread area (obtained by the removal of the top sidewall). The opening further leads to a tire cavity of the second tire.

According to some implementations, a third tire is then concentrically disposed within the second tire's tire cavity. For example, the third tire may be positioned within the second tire's tire cavity in the same or a similar manner to the positioning of the second tire within the first tire's cavity. Thus, the first, second, and third tires may be “stacked” inside of each other to form a concentric tire structure with a diameter that is not substantially larger than the diameter of the first tire, but which has less negative space due to the second and third tires filling the void.

According to some implementations, the detached sidewall that was removed from the second tire (and/or the detached sidewall from the first tire) may be positioned within any gaps, spaces, or interstices between the first and second tire and/or between the second and third tire (such as between the inner face of a tire and the tread of another tire).

According to some implementations of the invention, the diameter of the third tire is smaller than the diameter of the second tire. This notwithstanding, the diameter of the third tire may be the same size as the diameter of the second tire, so long as the tires may be stretched and/or compressed to allow for creation of the concentric tire structure.

According to some implementations of the invention, the invention includes additional tires, with one sidewall of each tire removed (with the possible exception of the innermost tire, for which the sidewall is removed in some implementations, but is not removed in other implementations). The tire structure may include up to as many tires as can possibly fit within the structure, with some or all of the inner tires optionally having smaller diameters than some or all of the outer tires, and with none, some, or all of the detached sidewalls incorporated into the structure between any or each of the tire layers.

According to some implementations of the invention, some or all of the tires are close-fitting, such that a majority of the surface area of the annular tread area of an inner tire comes into contact with the inner face of an outer tire. For example, a majority of the surface area of the second tire's tread may come into contact with the inner face of the first tire, as opposed to using a much smaller tire for the second tire such that there is a gap between the tread of the second tire and the inner face of the first tire. This notwithstanding, according to some implementations of the invention, the tires are not close-fitting, but rather the gap(s) between tire layers are filled with detached sidewalls or a suitable fill material, as discussed below.

According to some implementations of the invention, the cavity of the innermost tire (e.g., the cavity of the second tire if the structure only has two tires, or the cavity of the eighth tire if the structure has eight tires), may be filled with a fill material. Such a fill material can be any of the following: tires (whole or partial, shredded, ground, melted, or otherwise changed or unchanged), cement (dry or wet), concrete, gravel (of any suitable size, including pebbles or course rock, and of any suitable gravel material), earth (including dirt, soil, sand, clay, compost, or any other like material), organic matter, bricks (or other man-made construction compounds, such as ceramics), rubber, asphalt, woodchips, sawdust, wood, plastic, metal, glass, resin, waste products, recycled materials, or any other suitable fill material. Moreover, according to some implementations, the fill material need not be confined solely to the cavity of the innermost tire, but it can fill or cover any other portions of the tire structure, such as any interstices between tire layers, openings in tires, gaps between tire tread, or any other negative space in or on the tire structure.

According to some implementations of the invention, the bottom sidewall of the second tire (that is still attached to the annular tread area) is adjacent to the bottom sidewall of the first tire, such that the opening of each tire is facing the same general direction (and the hole of each tire, if any, is facing the same general direction). In some implementations, all of the tires in the tire structure are positioned so that the bottom sidewalls are adjacent to the bottom sidewalls of the tires in subsequent and proceedings layers, such that the opening of each tire is facing in the same general direction. When the tire structure is arranged such, there is an open face and a closed face, where the open face is the face from which the sidewall of each tire has been removed, and the closed face is the face on which the sidewall of each tire remains attached. Thus, in some implementations, the closed face may contain a hole defined by the inner edge of the bottom sidewall of the innermost tire. In some implementations, this hole may be filled will a filler material, covered with a detached sidewall or another covering, or plugged with compressed tire or other material.

According to some implementations of the invention, the tires in the tire structure may alternate orientations. For example, the opening of the first tire may face upwards, the opening of the second tire may face downwards, the opening of the third tire may face upwards, and so on. In these implementations, the tire structure would not have an open face and a closed face, but rather a top face and a bottom face, each of which is “closed” in the sense that a sidewall partially blocks access to the interior cavity of the tire structure (on the bottom face, such sidewall is the attached sidewall of the first tire, while on the top face, such sidewall is the attached sidewall of the second tire). In such implementations, the inner cavity may be filled with a filler material, and one or both holes may be open or filled, covered, or plugged.

According to some implementations of the invention, the tires used can be tires of any suitable size, thickness, width, color, or tire type, and may have any or no degree of wear or tread type.

According to other implementations of the invention, the invention is a method for repurposing tires. In some implementations, the method involves removing one sidewall (e.g., if the tire is laid on its side, the top sidewall) from a first tire to create an opening (which opening is defined by the top edge of the tire's annular tread area) that leads to a tire cavity, and then positioning a second tire within the tire cavity to form a concentric tire structure.

According to some implementations of the invention, the method includes using tires of particular sizes. For example, in some implementations, the diameter of the first tire is greater than the diameter of the second tire, such that the second tire more easily fits into the tire cavity. However, according to some implementations, the diameter of the first tire need not be greater than the diameter of the second tire, such as if the first tire is stretched and/or the second tire is compressed to accommodate positioning the second tire within the first tire's cavity.

According to some implementations of the invention, the method includes a step wherein the tires used to create the concentric tire structure are selected based on the size of the tires. For example, in some implementations, the first and second tires are each selected based on their diameters, or the tires are selected based on their diameters relative to each other, such that the diameter of the first tire is greater than the diameter of the second tire.

According to some implementations, the method further involves removing a sidewall from the second tire (such as the upper sidewall of the tire if the tire is laid on its side). Thus, a second opening is created (where the opening is defined by the upper edge of the annular tread area of the second tire), and the opening leads to a tire cavity of the second tire. The sidewall may be removed from the second tire after the second tire has been positioned within the tire cavity of the first tire, but in some implementations the sidewall of each tire is removed prior to assembling the concentric tire structure.

According to some implementations, the method further includes positioning a third tire within the second tire cavity so as to be concentrically aligned with the second tire (in the same or a similar manner to the way the second tire is positioned within the tire cavity of the first tire).

According to some implementations, the method includes repeating the process any suitable number of times to create a concentric tire structure comprising any suitable number of tires. For each tire, one sidewall is removed to create a tire cavity, and then another tire is placed within the tire cavity. For the innermost tire, the sidewall may be (but need not be) removed. The sidewalls may be removed prior to positioning any tires within another tire's cavity, or the sidewall of any particular tire may be removed after it has been positioned within another tire cavity (but before another tire is positioned within that particular tire's cavity).

In some implementations, the tires may be of any suitable size (or sizes), but in some implementations, the diameter of each tire is greater than the diameter of the tire positioned within that tire's cavity, such that the concentric tire structure is made from many tires, each of which is a different size to allow the tires to fit together in a suitable manner. Furthermore, in some implementations, the method includes selecting the tires based on their sizes. For example, a tire with a large diameter compared to the diameters of other available tires may be selected for use as the first tire, and then each subsequently selected tire may have a diameter that is less than the diameter of the proceeding tire.

In some implementations, the method includes placing a detached sidewall (e.g., the sidewall that has been removed from the first tire, the sidewall that has been removed from the second tire, or the sidewall that has been removed from any other tire) into an interstitial space between the first tire and the second tire. In some implementations, the interstitial space is between the inner face of the first tire and the annular tread area of the second tire.

In some implementations, the method includes placing one or more detached sidewalls (including up to all of the detached sidewalls from the tires used in the concentric tire structure, and/or including detached sidewalls from tires not used in the concentric tire structure) into one or more interstitial spaces between any of the tire layers in the concentric tire structure. As an example, the detached sidewall from the first tire may be placed between the first and second tires, the detached sidewall from the second tire may be placed between the second and third tires, the detached sidewall from the third tire may be placed between the third and fourth tires, and so on. As another example, any or all of the detached sidewalls may be placed between any tire layers where there is space, such as by placing multiple detached sidewalls between any two tires.

According to some implementations of the invention, after the concentric tire structure has been assembled, the innermost tire (which may or may not have one of its sidewalls removed) has a central cavity. This notwithstanding, the concentric tire structure need not have a central cavity, but may contain enough tires and detached sidewalls that the void space of each tire is substantially filled.

According to some implementations of the invention, the method further comprises filling the central cavity with a suitable fill material. Such a fill material can be any of the following: tires (whole or partial, shredded, ground, melted, or otherwise changed or unchanged), cement (dry or wet), concrete, gravel (of any suitable size, including pebbles or course rock, and of any suitable gravel material), earth (including dirt, soil, sand, clay, compost, or any other like material), organic matter, bricks (or other man-made construction compounds, such as ceramics), rubber, asphalt, woodchips, sawdust, wood, plastic, metal, glass, resin, waste products, recycled materials, or any other suitable fill material. Moreover, according to some implementations, the fill material need not be confined solely to the cavity of the innermost tire, but it can fill or cover any other portions of the tire structure, such as any interstices between tire layers, openings in tires, gaps between tire tread, or any other negative space in or on the tire structure.

According to some implementations of the invention, the method includes incorporating the concentric tire structure (or any variant thereof with any number of tires included, with any number of sidewalls included, whether filled or unfilled) into a structure. In some implementations, the structure is a road base, a railroad base, a foundation base, a structural wall, a retaining wall, a guard rail, a fence, a sound barrier, a blast barrier, a collision barrier, an insulation barrier, a structural pillar, building block, or any other construction project or useful structure or structural component. The concentric tire structure may be incorporated into the structure in any reasonable manner, such as by using the concentric tire structure as a form or a scaffold for the structure, and then adding additional construction materials such as foam, wood, concrete, and/or any other suitable construction materials.

According to some implementations of the invention, the method includes attaching together two or more concentric tire structures (created in accordance with the methods described above). The concentric tire structures may be attached together in any reasonable manner, including but not limited to tying, wiring, melting, attaching with an adhesive, bracketing, and/or using another type of connector to attach them. In some implementations, the attached concentric tire structures may then be incorporated into another structure, such as a road base, a railroad base, a foundation base, a structural wall, a retaining wall, a guard rail, a fence, a sound barrier, a blast barrier, a collision barrier, an insulation barrier, a structural pillar, a building block, or any other construction project or useful structure or structural component.

According to some implementations of the invention, the method includes inserting a post into the central cavity. The post may be a pillar, a pole, a light post, a signpost, a fence post, a beam, a lamp, or any other type of post. The post may be inserted such that only the base of the post is contained within the concentric tire structure, or it may be inserted through the hole (if any) in the bottom of the concentric tire structure, such that a middle portion of the post is contained within the concentric tire structure, with each end of the post protruding from either side of the concentric tire structure. In some implementations, the concentric tire structure operates as a base or stabilizer for a vertical or horizontal post.

According to some implementations, the method further includes burying the concentric tire structure after a post has been inserted, thus allowing the concentric tire structure to operate as a stable base for the post.

According to some implementations of the invention, the method further includes incorporating the concentric tire structure (or any variant thereof with any number of tires included, with any number of sidewalls included, whether filled or unfilled) into an irrigation system or a drainage system. In some implementations, the concentric tire structure is incorporated into such irrigation or drainage system with an open face (for instance, the side from which the sidewalls of the tires have been removed) positioned facing generally downward. In some implementations, this allows water to flow through interstices between the tires in the concentric tire structure, while the closed face (facing generally upward), prevents dirt or other materials from falling and plugging the interstices.

According to some implementations, the method further involves covering the concentric tire structure (as incorporated into an irrigation or drainage system) with a covering. In some implementations, the covering is earth, gravel, concrete, canvas, or any other suitable covering.

According to some implementations of the invention, all or part of the method is automated. For example, according to some implementations, the method includes loading any number of tires onto a conveyor, which has the necessary sensors to detect the tires, and which transports the tires to another location or locations. According to some implementations, the method includes using an automated system that is capable of identifying the size of the tire entering the system. In some implementations, the sizing data is stored in the system or in external equipment, such as one or more robotic manipulation arms. For example, one or more overhead stereo cameras may be used for sizing, but any suitable method (manual or automated) may be used at any step of the process, including in sizing the tires. According to some implementations, the tires may be docked in a particular position (manually or automatically), for easy and repeatable robot and effector grasping, and the system may include sensors and/or additional equipment for ensuring that the tires are oriented properly. According to some implementations, the tires may be manipulated, grasped, moved, stretched, and cut (e.g., for removal of the top sidewalls), and the concentric tire structures assembled, by one or more robotic arms, effectors, graspers, manipulators, or other automated equipment capable of partially or completely assembling the concentric tire structure in accordance with any or all of the method steps described above. According to some implementations, the method may include automated means of storing assembled concentric tire structures in storage areas and/or relocating them to docking stations for loading and shipment. According to some implementations, the automated system includes one or more electrical panels, safety nets, reset buttons, or any other component that may generally be used in connection with automated assembly systems.

### BRIEF DESCRIPTION OF THE DRAWINGS

The objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional specificity and detail through the use of the accompanying drawings, in which:

FIG. 1 shows a top perspective view of an ordinary tire as described in the prior art.

FIG. 2 shows a top perspective view of a modified tire, in accordance with a representative embodiment of elements of the present invention.

FIG. 3 shows a perspective top view of a deconstructed concentric tire structure, in accordance with a representative embodiment of the present invention.

FIG. 4 shows a top view of a concentric tire structure, in accordance with a representative embodiment of the present invention.

### DETAILED DESCRIPTION OF THE INVENTION

A description of embodiments of the present invention will now be given with reference to the Figures. It is expected that the present invention may take many other forms and shapes, hence the following disclosure is intended to be illustrative and not limiting, and the scope of the invention should be determined by reference to the appended claims.

The instant invention is a concentric tire structure that may be formed from worn-out, spent, defective, and/or repurposed tires, and a method for making the same. The tire structure is not only useful for repurposing old tires that may otherwise be a source of pollutants, an environmental hazard, a health hazard, a troublesome waste source, or a general nuisance, but the tire structure may also be incorporated into a wide variety of useful and beneficial structures and projects, thereby allowing substantial value to be derived from an otherwise problematic source of waste.

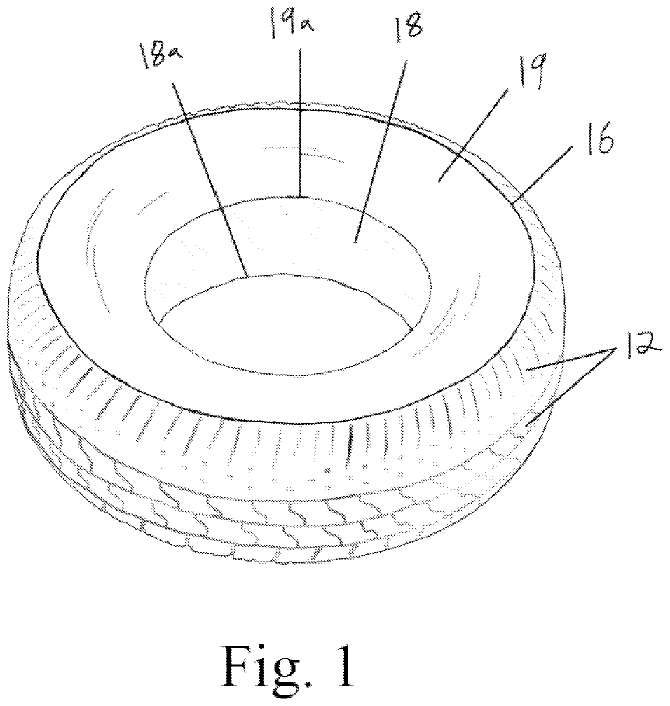

Referring to FIG. 1, according to some embodiments of the invention, the invention is formed from tires that have been modified. FIG. 1 shows a tire prior to any modifications. Before modification, the tires have an annular tread area 12 (which is the portion of the tire that generally makes contact with the surface of a road when in use on the wheel of a vehicle), a top sidewall 19, and a bottom sidewall 18. The annular tread area may have a single type of tread, multiple types of tread, or no tread (for instance, on a treadles tire or a tire that has been worn smooth). The top sidewall is connected (e.g., radially attached) to a top edge 16 of the annular tread area. The bottom sidewall is connected (e.g., radially attached) to a bottom edge (not pictured) of the annular tread area. Such tires sometimes have a top hole that is defined by an inner edge 19a of the top sidewall, and such tires sometimes have a bottom hole that is defined by an inner edge 18a of the bottom sidewall. However, unmodified tires do not have an opening that is defined by the top edge of the annular tread area, due to the presence of the top sidewall.

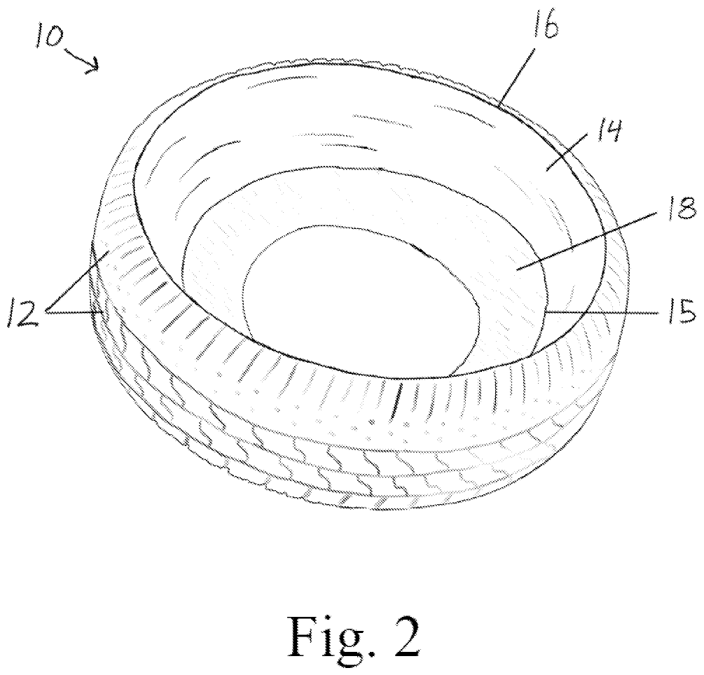

Referring now to FIG. 2, according to some embodiments of the invention, the invention includes one or more modified tires 10. The modified tire(s) do not have a top sidewall, because the top sidewall has been removed. According to some embodiments, the modified tire (like an unmodified tire) has an annular tread area 12, which further has a bottom edge 15 that is attached to a bottom sidewall 18. Additionally, the annular tread area of the modified tire has a top edge 16, but the top edge is not attached to a sidewall because the top sidewall has been removed. Instead, the top edge now defines an opening. This provides greater exposure for an inner face 14 of the tire. Furthermore, the opening leads to a tire cavity that comprises the full interior of the modified tire. The tire cavity is roughly cylindrical, with a diameter approximately equal to the distance between the inner face of the tire on one side and the inner face of the tire directly opposite, and with a height approximately equal to the height of the modified tire.

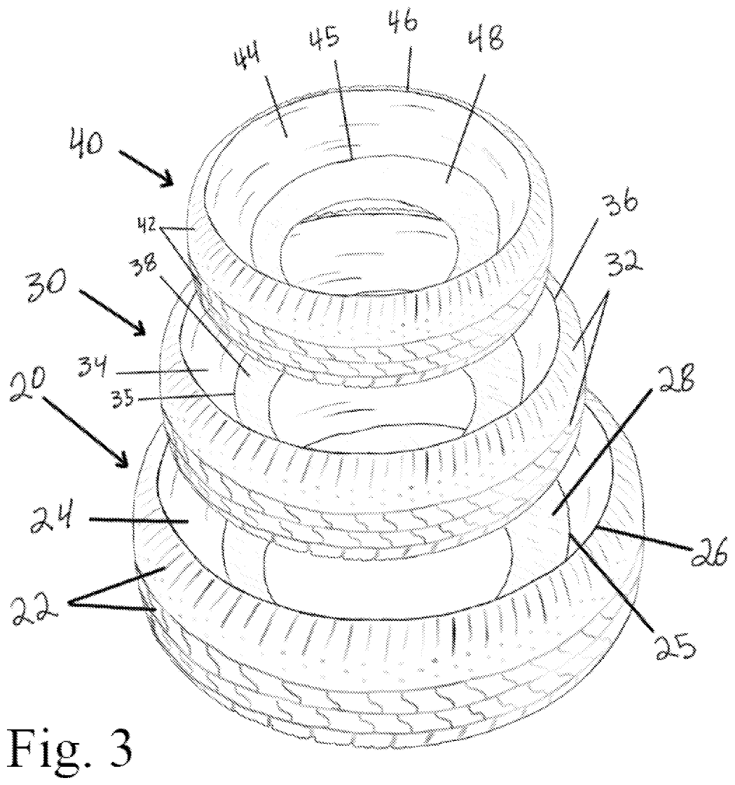

Referring now to FIG. 3, according to some embodiments of the invention, the invention is a concentric tire structure that is made of modified tires (such as the one depicted in FIG. 2). For instance, according to some embodiments, the concentric tire structure includes a first tire 20 having an inner face 24, and having an annular tread area 22 with a bottom edge 25 attached to a bottom sidewall 28, and having a top edge 26 that defines an opening leading to a tire cavity.

According to some embodiments, the structure further includes a second tire 30 concentrically disposed within the tire cavity of the first tire. The second tire may be an ordinary tire (such as the one depicted in FIG. 1). However, in some embodiments of the invention, the second tire is a modified tire (such as the one depicted in FIG. 2), having an inner face 34, and having an annular tread area 32 with the bottom edge 35 attached to a bottom sidewall 38, but having a top edge 36 that is not attached to a top sidewall, but rather that defines an opening in the second tire leading to a tire cavity of the second tire.

According to some embodiments, the structure further includes a third tire 40 concentrically disposed within the tire cavity of the second tire. The third tire may be an ordinary tire (such as the one depicted in FIG. 1). However, in some embodiments of the invention, the third tire is a modified tire (such as the one depicted in FIG. 2), having an inner face 44, and having an annular tread area 42 with the bottom edge 45 attached to a bottom sidewall 48, but having a top edge 46 that is not attached to a top sidewall, but rather that defines an opening in the third tire leading to a tire cavity of the third tire.

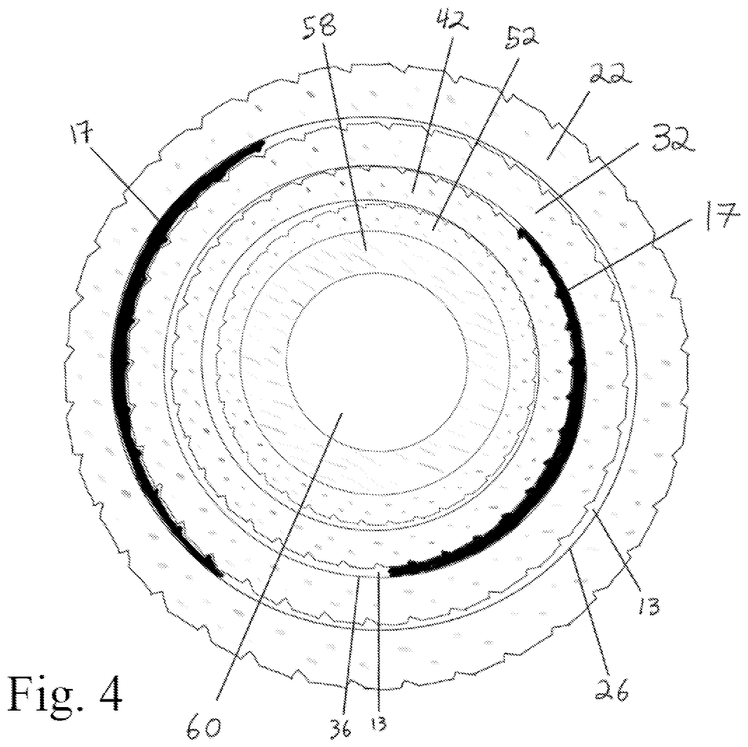

With reference now to FIG. 4, according to some embodiments, the concentric tire structure may include any number of tires. In some embodiments, all of the tires, including the innermost tire 50 are modified tires (such as the one represented in FIG. 2), but in some embodiments, all of the tires except the innermost tire are modified tires, while the innermost tire is an ordinary tire. In some embodiments, the structure includes twenty or more tires in this manner, but in some embodiments, the structure includes between seven and thirteen tires. In other embodiments, the structure only contains two to six tires.

According to some embodiments, the innermost tire 50 is a modified tire (as depicted in FIG. 2), having a bottom sidewall 58 and an annular tread area 52. The annular tread area has a top edge 56 defining an opening that leads to a central cavity 60 of the concentric tire structure.

According to some embodiments of the invention, the concentric tire structure further includes at least one detached sidewall 17. In some embodiments, the detached sidewall may be positioned in an interstitial space 13 between tire layers. For example, a detached sidewall may be placed in an interstitial space between the inner face of the first tire (not pictured, but located behind the top edge 26 of the annular tread area 22 of the first tire) and the annular tread area 32 of the second tire. As another example, a detached sidewall may be positioned between the inner face of the second tire (not pictured, but located behind the top edge 36 of the annular tread area of the second tire) and the annular tread area 42 of the third tire. According to some embodiments, any number of detached sidewalls may be positioned between any tire layers in like manner. The sidewalls may be, but need not be, the top sidewalls that were removed from the modified tires. Incorporating sidewalls into the concentric tire structure not only solves the problem of sidewall disposal, but it can also increase the density, durability, rigidity, and/or other useful properties of the concentric tire structure.

With reference to both FIG. 3 and FIG. 4, the following paragraphs provide additional details about the concentric tire structure, uses for the concentric tire structure, and methods for assembling the concentric tire structure.

According to some embodiments of the invention, the bottom side of the concentric tire structure has a hole defined by the inner edge of the bottom sidewall 58 of the innermost tire 50. The hole is smaller than the opening defined by the top edge 56 of the annular tread area 52, which is obtained by removal of the top sidewall. According to some embodiments, the hole provides an additional point of access to the central cavity 60, but in other embodiments, the hole is sealed, covered, plugged, or filled with any suitable sealing, covering, plugging, or filling material. In either case, the removal of sidewalls from the upper face of the tires in the concentric tire structure renders the upper face of the concentric tire structure more open than the bottom face. Thus, the structure has an open face (FIG. 4), and a closed face (not pictured). As noted above, the closed face need not be entirely closed, but may have a hole.

According to some embodiments of the invention, the second tire 30 is concentrically disposed within the tire cavity of the first tire 20. For example, the second tire may be placed through the opening defined by the top edge 26 of the annular tread area 22, and positioned so that the annular tread area 32 of the second tire is facing, contacting, or substantially coming into contract with the inner face 24 of the first tire. Thus, the first and second tires form a concentric tire structure.

According to some embodiments, the first tire 20 has a diameter that is larger than the diameter of the second tire 30. Thus, the second tire may more easily fit inside the tire cavity of the first tire. Notwithstanding the above, due to the elastic quality of many tires, the tires may also be tires of the same diameter, with the first tire being stretched or the second tire being compressed (or both) to allow for the second tire to be concentrically disposed within the first tire's cavity. Moreover, according to some embodiments, the second tire 30 has a diameter that is larger than the diameter of the third tire 40, thereby allowing the third tire to more easily fit inside the tire cavity of the second tire. This notwithstanding, the diameter of the third tire may be the same as the diameter of the second tire, with one or both tires stretched or compressed to allow for the concentric disposition of the third tire within the cavity of the second. Furthermore, according to some embodiments of the invention, any of the tires in the concentric tire structure have diameters that are smaller than the diameter of the tire within which such tires are disposed. For example, each tire may have a different diameter, with the first tire having the largest diameter and the innermost tire 50 having the smallest diameter. That said, any tire or combination of tires in the concentric tire structure may have a diameter that is the same as the diameter of one or more adjacent tires, as long as the tires may be stretched or compressed to accommodate concentric disposition of the tires.

According to some embodiments, the concentric tire structure has a diameter that is not substantially larger than the diameter of the first tire 20, but the concentric tire structure has less negative space due to additional tires (e.g., 30, 40, 50) filling the tire cavity. Moreover, according to some embodiments, the concentric tire structure has less negative space because one or more detached sidewalls 17 (such as the ones that were removed from the modified tires in the structure) may be positioned within any gaps, spaces, or interstices between the first and second tire and/or between the second and third tire (such as between the inner face of a tire and the tread of another tire). According to some embodiments, detached sidewalls may be placed between the bottom sidewall of one tire (e.g., 28) and the bottom sidewall of another tire (e.g., 38). This can lead to a more uniform tire structure if tires of different widths are used.

According to some embodiments of the invention, some or all of the tires are close-fitting, such that a majority of the surface area of the annular tread area of an inner tire comes into contact with the inner face of an outer tire. For example, a majority of the surface area of the second tire's tread 32 may come into contact with the inner face 24 of the first tire, as opposed to using a much smaller tire for the second tire such that there is a gap between the tread of the second tire and the inner face of the first tire. This notwithstanding, according to some implementations of the invention, the tires are not close-fitting, but rather the gap(s) between tire layers are filled with detached sidewalls 17 or a suitable fill material.

According to some embodiments of the invention, the cavity 60 of the innermost tire 50 may be filled or partially filled with a fill material. Such a fill material can be any of the following: tires (whole or partial, shredded, ground, melted, or otherwise changed or unchanged), cement (dry or wet), concrete, gravel (of any suitable size, including pebbles or course rock, and of any suitable gravel material), earth (including dirt, soil, sand, clay, compost, or any other like material), organic matter, bricks (or other man-made construction compounds, such as ceramics), rubber, asphalt, woodchips, sawdust, wood, plastic, metal, glass, resin, waste products, recycled materials, or any other suitable fill material. Moreover, according to some embodiments, the fill material need not be confined solely to the cavity of the innermost tire, but it can fill or cover any other portions of the tire structure, such as any interstices 13 between tire layers, openings in tires, gaps between tire tread, or any other negative space in or on the tire structure.

According to some embodiments of the invention, the bottom sidewall 38 of the second tire 30 is adjacent to the bottom sidewall 28 of the first tire 20, such that the opening of each tire is facing the same general direction (e.g., upwards). Likewise, in some embodiments, all of the tires in the concentric tire structure are positioned in like manner, so that the bottom sidewalls are adjacent to the bottom sidewalls of the tires in subsequent and proceedings layers, such that the opening of each tire is facing in the same general direction. When the tire structure is arranged such, there is an open face and a closed face, as discussed above, where the open face is the face from which the sidewall of each tire has been removed, and the closed face is the face on which the sidewall of each tire remains attached.

According to other embodiments of the invention, however, the tires in the tire structure may alternate orientations. For example, the opening of the first tire may face upwards, the opening of the second tire may face downwards, the opening of the third tire 40 may face upwards, and so on. In these implementations, the tire structure does not have an open face and a closed face, but rather a top face and a bottom face, each of which is “closed” in the sense that a sidewall partially blocks access to the interior cavity of the tire structure (on the bottom face, such sidewall is the bottom sidewall 28 of the first tire, while on the top face, such sidewall is the bottom sidewall of the second tire 38). In such embodiments, the inner cavity may be filled with a filler material. Moreover, there may be a hole on each side, or one or both holes may be filled, covered, plugged, or otherwise closed.

According to some embodiments of the invention, ay of the tires in the concentric tire structure can be tires of any suitable size, thickness, width, color, or tire type, and may have any or no degree of wear or tread type.

The following paragraphs refer to FIGS. 1-4 in describing a method for repurposing tires by creating one or more of the concentric tire structures in one or more of the configurations recited above.

According to some embodiments of the invention, the method involves removing the top sidewall 19 from a tire to create a modified tire 10. The modified tire has an opening defined by the top edge 16 of the modified tire's annular tread area 12, and which leads to a tire cavity. After that, a second tire 30 is positioned within the tire cavity to form a concentric tire structure.

According to some embodiments, the method further involves removing the top sidewall 19 from the second tire 30. Thus, a second opening is created (where the opening is defined by the upper edge 16 of the annular tread area 32 of the second tire), and the opening leads into a tire cavity of the second tire. The sidewall may be removed from the second tire after the second tire has been positioned within the tire cavity of the first tire, but in some embodiments the sidewall of each tire is removed prior to assembling the concentric tire structure.

According to some embodiments, the method further includes positioning a third tire 40 within the second tire cavity so as to be concentrically aligned with the second tire 30 (in the same or a similar manner to the way the second tire is positioned within the tire cavity of the first tire 20).

According to some embodiments, the method further involves removing the top sidewall 19 of the third tire, and positioning a fourth tire in the resulting cavity. Indeed, according to some embodiments, the process may be repeated any number of times until it is no longer possible to position an additional tire within the cavity 60 of the innermost tire 50.

According to some embodiments of the invention, the method includes using tires of particular sizes. For example, in some embodiments, the diameter of the first tire 20 is greater than the diameter of the second tire 30, such that the second tire more easily fits into the tire cavity of the first tire. However, according to some implementations, the diameter of the first tire need not be greater than the diameter of the second tire, such as if the first tire is stretched and/or the second tire is compressed to accommodate positioning the second tire within the first tire's cavity.

According to some embodiments of the invention, the method includes a step wherein the tires (e.g., 20, 30, 40, 50) used to create the concentric tire structure are selected based on the size of the tires. For example, in some embodiments, the first 20 and second 30 tires are each selected based on their diameters, or the tires are selected based on their diameters relative to each other, such that the diameter of the first tire is greater than the diameter of the second tire. Moreover, in some embodiments, the third tire 40 is also selected based on having a diameter that is smaller than the diameter of the second tire. Each additional tire may be selected in like manner.

In some embodiments, the method includes placing at least one detached sidewall 17 (e.g., the sidewall that has been removed from the first tire, the sidewall that has been removed from the second tire, or the sidewall that has been removed from any other tire) into an interstitial space 13 between the first tire and the second tire. In some embodiments, the interstitial space is between the inner face 24 of the first tire 20 and the annular tread area 32 of the second tire 30. In some embodiments, the interstitial space is between the inner face 34 of the second tire and the annular tread area 42 of the third tire. In some embodiments, the method includes placing one or more detached sidewalls into one or more interstitial spaces between any or all of the tire layers in the concentric tire structure. Furthermore, multiple detached sidewalls may be placed into a single interstitial space, or a single detached sidewall may be placed into multiple interstitial spaces (for example, by placing one part of the detached sidewall into one interstitial space, and another part of the detached sidewall into another interstitial space, with or without physically dividing the detached sidewall into multiple parts).

According to some embodiments of the invention, after the concentric tire structure has been assembled, the innermost tire 50 (which may or may not have one of its sidewalls removed) has a central cavity 60. This notwithstanding, the concentric tire structure need not have a central cavity, but may contain enough tires and detached sidewalls 17 that the void space of each tire (including the void space of the innermost tire) is substantially filled. As an example, the innermost tire may be compressed such that it no longer has a central cavity.

According to some embodiments of the invention, the method further comprises filling the central cavity 60 with a suitable fill material. Such a fill material can be any of the following: tires (whole or partial, shredded, ground, melted, or otherwise changed or unchanged), cement (dry or wet), concrete, gravel (of any suitable size, including pebbles or course rock, and of any suitable gravel material), earth (including dirt, soil, sand, clay, compost, or any other like material), organic matter, bricks (or other man-made construction compounds, such as ceramics), rubber, asphalt, woodchips, sawdust, wood, plastic, metal, glass, resin, waste products, recycled materials, or any other suitable fill material. Moreover, according to some implementations, the fill material need not be confined solely to the cavity of the innermost tire, but it can fill or cover any other portions of the tire structure, such as any interstices 13 between tire layers, openings in tires, gaps between tire tread, or any other negative space in or on the tire structure.

According to some embodiments of the invention, the method includes incorporating the concentric tire structure (or any variant thereof with any number of tires included, with any number of sidewalls 17 included, whether filled or unfilled) into a structure. In some implementations, the structure is a road base, a railroad base, a foundation base, a structural wall, a retaining wall, a guard rail, a fence, a sound barrier, a blast barrier, a collision barrier, an insulation barrier, a structural pillar, building block, or any other construction project or useful structure or structural component. The concentric tire structure may be incorporated into the structure in any reasonable manner, such as by using the concentric tire structure as a form or a scaffold for the structure, and then adding additional construction materials such as foam, wood, concrete, and/or any other suitable construction materials.

According to some embodiments of the invention, the method includes attaching together two or more concentric tire structures (created in accordance with the method(s) described above). The concentric tire structures may be attached together in any reasonable manner, including but not limited to tying, wiring, melting, attaching with an adhesive, bracketing, and/or using another type of connector to attach them. In some implementations, the attached concentric tire structures may then be incorporated into another structure, such as a road base, a railroad base, a foundation base, a structural wall, a retaining wall, a guard rail, a fence, a sound barrier, a blast barrier, a collision barrier, an insulation barrier, a structural pillar, a building block, or any other construction project or useful structure or structural component.

According to some embodiments of the invention, the method includes inserting a post into the central cavity 60. The post may be a pillar, a pole, a light post, a signpost, a fence post, a beam, a lamp, or any other type of post. The post may be inserted such that only the base of the post is contained within the concentric tire structure, or it may be inserted such that a middle portion of the post is contained within the concentric tire structure, with each tip of the post protruding from either side of the concentric tire structure (i.e., so that the post in inserted through the hole in the bottom of the concentric tire structure). In some embodiments, the concentric tire structure operates as a base or stabilizer for a vertical or horizontal post.

According to some embodiments, the method further includes burying the concentric tire structure after a post has been inserted, thus allowing the concentric tire structure to operate as a stable base for the post.

According to some embodiments of the invention, the method further includes incorporating the concentric tire structure (or any variant thereof, with any number of tires included, with any number of sidewalls 17 included, whether filled or unfilled) into an irrigation system or a drainage system. In some embodiments, the concentric tire structure is incorporated into such irrigation or drainage system with the open face positioned facing generally downward. In some embodiments, this allows water to flow through interstices between the tires in the concentric tire structure, while the closed face (facing generally upward), prevents dirt or other materials from falling and plugging the interstices.

According to some embodiments, the method further involves covering the concentric tire structure (as incorporated into an irrigation or drainage system) with a covering. In some embodiments, the covering is earth, gravel, concrete, canvas, or any other suitable covering.

According to some embodiments, the method involves encasing the concentric tire structure in concrete to create a concrete building block. The density of the concentric tire structure allows for significantly less concrete to be used in the construction of such a block, and it also gives the block unique physical properties.

According to some embodiments of the invention, all or part of the method is automated. For example, according to some embodiments, the method includes loading any number of tires onto a conveyor, which has the necessary sensors to detect the tires, and which transports the tires to another location or locations. According to some embodiments, the method includes using an automated system that is capable of identifying the size of the tire entering the system. In some embodiments, the sizing data is stored in the system or in external equipment, such as one or more robotic manipulation arms. For example, one or more overhead stereo cameras may be used for sizing, but any suitable method (manual or automated) may be used at any step of the process, including in sizing the tires. According to some embodiments, the tires may be docked in a particular position (manually or automatically), for easy and repeatable robot and effector grasping, and the system may include sensors and/or additional equipment for ensuring that the tires are oriented properly. According to some embodiments, the tires may be manipulated, grasped, moved, stretched, and cut (e.g., for removal of the top sidewalls 19), and the concentric tire structures assembled, by one or more robotic arms, effectors, graspers, manipulators, or other automated equipment capable of partially or completely assembling the concentric tire structure in accordance with any or all of the method steps described above. According to some embodiments, the method may include automated means of storing assembled concentric tire structures in storage areas and/or relocating them to docking stations for loading and shipment. According to some embodiments, the automated system includes one or more electrical panels, safety nets, reset buttons, or any other component that may generally be used in connection with automated assembly systems.

The person of ordinary skill in the art will readily recognize that the concentric tire structures recited herein and the methods of making the same are great improvements over prior methods for repurposing spent, worn-out, defective, or other tires. A person of ordinary skill in the art will also recognize the many useful qualities of concentric tire structures for construction and other projects in which such structures may be used.

What is claimed is:

1. A tire structure comprising a first tire and a second tire, wherein the first tire further comprises an annular tread area and a bottom sidewall that is radially attached to a bottom edge of the annular tread area, wherein a top edge of the annular tread area obtained by removing a top sidewall defines an opening that leads to a tire cavity, and wherein the second tire is concentrically disposed within the tire cavity.

2. The tire structure as recited in claim 1, wherein the first tire has a diameter that is greater than the diameter of the second tire.

3. The tire structure as recited in claim 1, wherein a detached sidewall is disposed between the first tire and the second tire.

4. The tire structure as recited in claim 3, wherein the second tire comprises a second annular tread area, and the detached sidewall is disposed between an inner face of the first tire and the second annular tread area.

5. The tire structure as recited in claim 1, wherein the second tire further comprises a second annular tread area and a second circular sidewall that is radially attached to a first edge of the second annular tread area, and wherein a second edge of the second annular tread area defines a second opening that leads to a second cavity.

6. The tire structure as recited in claim 5, wherein a third tire is concentrically disposed within the second cavity.

7. The tire structure as recited in claim 5, wherein the second cavity is at least partially filled with one or more of the following: tires, cement, gravel, dirt, soil, sand, clay, compost, organic matter, bricks, rubber, asphalt, woodchips, sawdust, wood, plastic, metal, glass, resin, waste products, or recycled materials.

8. The tire structure as recited in claim 5, wherein a majority of a surface area of the second annular tread area comes into contact with an inner face of the first tire.

9. The tire structure as recited in claim 5, wherein the second circular sidewall is disposed adjacent to the circular sidewall of the first tire.

10. A method for repurposing tires, wherein the method comprises:
removing a top sidewall from a first tire to create an opening that is defined by a top edge of an annular tread area of the first tire, wherein the opening leads to a tire cavity; and
positioning a second tire within the tire cavity to form a concentric tire structure.

11. The method of claim 10 wherein a diameter of the first tire is greater than a diameter of the second tire.

12. The method of claim 11 wherein the method further comprises selecting the first tire and the second tire based on the diameter of the first tire and the diameter of the second tire.

13. The method of claim 10 wherein the method further comprises removing an upper sidewall from the second tire to create a second opening that is defined by an upper edge of a tread area of the second tire, wherein the second opening leads to a second cavity; and
positioning a third tire within the second cavity so as to be concentrically aligned with the second tire.

14. The method of claim 13 wherein a diameter of the first tire is greater than a diameter of the second tire, and wherein the diameter of the second tire is greater than a diameter of the third tire.

15. The method of claim 14 wherein the method further comprises selecting the first tire, the second tire, and the third tire based on the diameter of the first tire, the diameter of the second tire, and the diameter of the third tire.

16. The method of claim 10 wherein the method further comprises placing a detached sidewall into an interstitial space between the first tire and the second tire.

17. The method of claim 16 wherein the interstitial space is between an inner face of the first tire and a tread area of the second tire.

18. The method of claim 10 wherein an inner face of the concentric tire structure further defines a central cavity.

19. The method of claim 18, wherein the method further comprises filling the central cavity with one or more of the following: tires, cement, gravel, dirt, soil, sand, clay, compost, organic matter, bricks, rubber, asphalt, woodchips, sawdust, wood, plastic, metal, glass, resin, waste products, or recycled materials.

20. The method of claim 19, wherein the method further comprises incorporating the concentric tire structure into one of the following structures: a road base, a railroad base, a foundation base, a structural wall, a retaining wall, a guard rail, a fence, a sound barrier, a blast barrier, a collision barrier, an insulation barrier, a structural pillar, or a building block.

21. The method of claim 18, wherein the method further comprises inserting a post into the central cavity.

22. The method of claim 21, wherein the method further comprises burying the concentric tire structure.

23. The method of claim 10, wherein the method further comprises incorporating the concentric tire structure into one of the following structures: a road base, a railroad base, a foundation base, a structural wall, a retaining wall, a guard rail, a fence, a sound barrier, a blast barrier, a collision barrier, an insulation barrier, a structural pillar, or a building block.

24. The method of claim 10, wherein the method further comprises incorporating the concentric tire structure into an irrigation system or a drainage system.

25. The method of claim 24, wherein the concentric tire structure is positioned in the irrigation system or the drainage system with an open face generally facing downward.

26. The method of claim 25, wherein the method further comprises covering the concentric tire structure with earth, gravel, concrete, or other materials.

27. A concentric tire structure comprising a first tire, a second tire, and a third tire, wherein: each of the first tire, the second tire, and the third tire further comprises a bottom sidewall that is radially attached to an annular tread area and a top edge of the annular tread area that is obtained by removing a top sidewall, wherein the top edge of the annular tread area further defines an opening that leads to a tire cavity; wherein the second tire is concentrically disposed within the tire cavity of the first tire and the third tire is concentrically disposed within the tire cavity of the second tire.

28. The concentric tire structure of claim 27, wherein a diameter of the first tire is greater than a diameter of the second tire and the diameter of the second tire is greater than a diameter of the third tire.

29. The concentric tire structure of claim 27, wherein at least one of the top sidewall of the first tire, the top sidewall of the second tire, or the top sidewall of the third tire is disposed within an interstitial space between the first tire and the second tire or within an interstitial space between the second tire and the third tire.

30. The concentric tire structure of claim 29, wherein the interstitial space between the first tire and the second tire is between an inner face of the first tire and the annular tread area of the second tire, and wherein the interstitial space between the second tire and the third tire is between an inner face of the second tire and the annular tread area of the third tire.

31. The concentric tire structure of claim 27, wherein the concentric tire structure further comprises a fill material.

32. The concentric tire structure of claim 31, wherein the fill material is one or more of the following: tires, cement, gravel, dirt, soil, sand, clay, compost, organic matter, bricks, rubber, asphalt, woodchips, sawdust, wood, plastic, metal, glass, resin, waste products, or recycled materials.
